(19) United States
(12) Patent Application Publication
(10) Pub. No.: US 2019/0000106 A1
(43) Pub. Date: Jan. 3, 2019

(54) CHOCOLATE PRODUCTS AND METHODS OF MAKING THEREOF

(71) Applicant: Corn Products Development, Inc., Sao Paulo (BR)

(72) Inventors: Yadunandan Lal Dar, Bridgewater, NJ (US); Lia Mara M. Ribeiro, Mogi Guacu (BR); Peter Hendrikx, Marschacht (DE)

(21) Appl. No.: 15/638,701

(22) Filed: Jun. 30, 2017

(51) Int. Cl. A23G 1/40; A23G 1/00; A23G 1/36

(52) U.S. Cl. CPC A23G 1/40; A23G 1/36; A23G 1/0009; A23G 1/0036

(57) ABSTRACT

The present invention, in an embodiment, is a chocolate product that includes a carbohydrate such as starch, dextrin, or maltodextrin having a bulk density of 0.01 gram/cubic centimeter to 0.4 gram/cubic centimeter; 30 weight percent to 70 weight percent, based on the total weight of the carbohydrate and the vegetable oil, of a vegetable oil that is an unsaturated fat; and cocoa butter. In other embodiments, the present invention is a method of making a chocolate product.

### TECHNICAL FIELD

The present invention relates to chocolate compositions and methods of making chocolate compositions.

### BACKGROUND OF THE INVENTION

Chocolate products and method of making chocolate products are generally known.

### BRIEF SUMMARY OF THE INVENTION

In embodiments, the present invention is a chocolate product comprising a carbohydrate comprising at least one of starch, dextrin, or maltodextrin; wherein the carbohydrate has a bulk density of 0.01 gram/cubic centimeter to 0.4 gram/cubic centimeter. In embodiments, the chocolate product further includes vegetable oil; wherein the vegetable oil is an unsaturated fat; wherein a weight percent of the vegetable oil is 30 weight percent to 70 weight percent based on the total weight of the carbohydrate and the vegetable oil. In the embodiments, the chocolate product also includes cocoa butter.

In one or more of the embodiments detailed herein, the carbohydrate is selected from the group consisting of starch, dextrin, and maltodextrin.

In one or more of the embodiments detailed herein, the carbohydrate is maltodextrin.

In one or more of the embodiments detailed herein, the carbohydrate is tapioca maltodextrin.

In one or more of the embodiments detailed herein, the vegetable oil comprises at least one of corn oil, soy oil, canola oil, or sunflower oil.

In one or more of the embodiments detailed herein, a weight ratio of the carbohydrate to the vegetable oil is 1:2 to 2:1.

In one or more of the embodiments detailed herein, a weight of the cocoa butter is 0.01 weight percent to 20 weight percent of the product, based on a total weight of the product.

In one or more of the embodiments detailed herein, the total weight of the carbohydrate and the vegetable oil is at least 2 weight percent of the product, based on the total weight of the product.

In one or more of the embodiments detailed herein, the product includes 0.01 to 25 weight percent of saturated fat.

In one or more of the embodiments detailed herein, the product is free of emulsifiers.

In an embodiment, the present invention is a method comprising obtaining at least one of chocolate liquor, sugar, powder whey or milk powder; obtaining cocoa butter; obtaining a carbohydrate comprising at least one of starch, dextrin, or maltodextrin; wherein the carbohydrate has a bulk density of has a bulk density of 0.01 gram/cubic centimeter to 0.4 gram/cubic centimeter; obtaining a vegetable oil; wherein the vegetable oil is an unsaturated fat; mixing the vegetable oil and the carbohydrate to form an oil plated carbohydrate; mixing the at least one of chocolate liquor, sugar, powder whey or milk powder; the cocoa butter, and the oil plated carbohydrate to form a paste; conching the paste; after conching, heating the refined paste; after heating, cooling the heated refined paste to form a chocolate product; wherein the chocolate product comprises 0.01 to 25 weight percent of saturated fat; and wherein a weight percent of the vegetable oil is 30 weight percent to 70 weight percent based on a total weight of the carbohydrate and the vegetable oil.

In one or more of the embodiments detailed herein, the method further comprises refining the paste sufficiently to reduce a particle size of the paste.

In one or more of the embodiments detailed herein, the conching step is conducted for at least 20 hours.

In one or more of the embodiments detailed herein, the heating step comprises exposing the refined paste to a temperature of 40 degrees Celsius to 60 degrees Celsius.

In one or more of the embodiments detailed herein, the cooling step comprises exposing the heated refined paste to a temperature of 5 degrees Celsius to 15 degrees Celsius.

In one or more of the embodiments detailed herein, the carbohydrate in the method is maltodextrin.

In one or more of the embodiments detailed herein, the weight ratio of the carbohydrate to vegetable oil in the method is 1:2 to 2:1.

In one or more of the embodiments detailed herein, the method further comprises packaging the chocolate product to form a packaged chocolate product.

In one or more of the embodiments detailed herein, a weight of the cocoa butter in the method is 0.01 weight percent to 20 weight percent of the product, based on a total weight of the product.

In embodiments, the present invention is a packaged chocolate product comprising a carbohydrate comprising at least one of starch, dextrin, or maltodextrin, and maltodextrin; wherein the bulk density of the carbohydrate is 0.01 gram/cubic centimeter to 0.4 gram/cubic centimeter. In the embodiments, the chocolate product further includes vegetable oil; wherein the vegetable oil is an unsaturated fat; wherein a weight percent of the vegetable oil is 30 weight percent to 70 weight percent based on the total weight of the carbohydrate and the vegetable oil. In the embodiments, the product also includes cocoa butter.

### BRIEF DESCRIPTION OF THE DRAWINGS

The present invention can be further explained with reference to the attached drawings, wherein like structures are referred to by like numerals throughout the several views. The drawings shown are not necessarily to scale, with emphasis instead generally being placed upon illustrating the principles of the present invention. Therefore, specific structural and functional details disclosed herein are not to be interpreted as limiting, but merely as a representative basis for teaching one skilled in the art to variously employ the present invention.

FIG. 1 shows a non-limiting example of a mixer that may be used in an embodiment of the method of the present invention.

FIG. 2A shows a non-limiting example of a refiner having three rollers that may be used in an embodiment of the method of the present invention.

FIG. 2B is a magnified view of a refiner that may be used in an embodiment of the method of the present invention showing the refined product coming out of the refiner rollers.

FIG. 3 shows a non-limiting example of an air cooling tunnel that may be used in an embodiment of the method of the present invention.

### DETAILED DESCRIPTION OF THE INVENTION

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

Throughout the specification and claims, the following terms take the meanings explicitly associated herein, unless the context clearly dictates otherwise. The phrases “In some embodiments” and “in some embodiments” as used herein do not necessarily refer to the same embodiment(s), though it may. Furthermore, the phrases “In some embodiments” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The present invention relates to chocolate products and methods of making thereof. Cocoa butter is an important ingredient in chocolate as well as several types of chocolate based coatings. Cocoa butter provides several important properties including set provided by the crystallization of cocoa butter, melt provided by heat induced melting, rich buttery mouth coating, flavor, color and texture to chocolate.

The texture imparted by cocoa butter is difficult to replace at least in part because there is no water in chocolate and typical carbohydrate-based texturizers cannot be used as they all typically need moisture to function. Typical cocoa butter alternatives are based on naturally occurring saturated fat (e.g. palm oil) or artificially hydrogenated oils that produce saturated fat.

In embodiments, the present invention is a chocolate product comprising a vegetable oil and carbohydrate that may be used as a replacement of at least a portion of the cocoa butter or saturated-fat based cocoa butter alternatives in chocolate. In the embodiments, the present invention is a chocolate product that provides a cocoa butter alternative with a similar texture to that of cocoa butter and typical cocoa butter alternatives based on saturated fat or artificially hydrogenated oils.

As used herein, the term “fat” refers to the total amount of digestible, partially digestible and nondigestible fats or oils that are present in the embodiments of the present invention. As used herein, the terms “lipid”, “fat” and “oil” are synonymous.

As used herein, the term “carbohydrate” refers to the total amount of sugar alcohols, monosaccharides, disaccharides, oligosaccharides, digestible, partially digestible and non-digestible polysaccharides; and lignin or lignin like materials that are present in the embodiments of the present invention.

As used herein, the term “chocolate” refers to all chocolate or chocolate-like compositions and products with a fat phase or fat-like composition such that the composition can be processed according to the methods described herein. The term refers, for example, to chocolates with compositions that conform to the U.S. Standards of Identity (“SOI chocolate”), and compositions that do not conform to the U.S. Standards of Identity (“non-SOI chocolate”). The standards of identity for different kinds of chocolate are found in Title 21, Part 163 of the Code of Federal Regulations, herein incorporated by reference. “Pure CA 02842595 2014-02-10 SOT chocolate,” as that term is used herein, is chocolate that meets the Standards Of Identity for chocolate, and that is further substantially free of corn syrups or other carbohydrate syrups used as an extender. Non-SOI chocolates include those in which at least one of the standard ingredients of chocolate (i.e., one or more of the nutritive carbohydrate sweetener, the cocoa butter, and the milk fat) are replaced partially or completely, those in which components that have flavors that imitate milk, butter, or chocolate are added, and those in which other additions or deletions in the formulation are made that are outside FDA standards of identity of chocolate. As used herein, the term “chocolate” includes dark chocolate, baking chocolate, milk chocolate, sweet chocolate, semi-sweet chocolate, buttermilk chocolate, skim milk chocolate, mixed dairy product chocolate, low fat chocolate, white chocolate, aerated chocolates, compound coatings, and chocolate-like compositions, unless specifically identified otherwise. “Chocolate” also includes crumb solids or solids fully or partially made by a crumb process.

As used herein, “refining” refers to a process configured to reduce the particle size of a feed material. Non-limiting examples of a refining include grinding with a set of rollers.

As used herein, “conching” generally refers to a process of subjecting a substance to agitation sufficiently such that solids are coated with fat (e.g., cocoa butter), moisture content is lowered and/or volatile or unwanted flavours removed. Detailed information regarding “conching” may be found in Chocolate, Cocoa and Confectionary, 3^{rd} Edition, 1999, Author: Minifie, B W, Publisher: Aspen, Gaithersburg, Md., USA.

In embodiments, the present invention is a chocolate product comprising a carbohydrate comprising at least one of starch, dextrin, or maltodextrin; wherein the carbohydrate has a high surface area that is characterized by a low bulk density. The typical bulk density of starch is about 1 gram/cubic centimeter. In yet other embodiments, a high surface area starch has a bulk density of 0.01 gram/cubic centimeter to 0.4 gram/cubic centimeter. In embodiments, the chocolate product further includes vegetable oil; wherein the vegetable oil is an unsaturated fat; wherein a weight percent of the vegetable oil is 30 weight percent to 70 weight percent based on the total weight of the carbohydrate and the vegetable oil. In the embodiment, the chocolate product also includes cocoa butter.

In one or more of the embodiments detailed herein, the carbohydrate is maltodextrin.

In one or more of the embodiments detailed herein, the carbohydrate is tapioca maltodextrin.

In one or more of the embodiments detailed herein, the vegetable oil comprises at least one of corn oil, soy oil, canola oil, or sunflower oil.

In one or more of the embodiments detailed herein, the vegetable oil comprises at least one of corn oil, soy oil, canola oil, or sunflower oil.

In one or more of the embodiments detailed herein, a weight ratio of the carbohydrate to the vegetable oil is 1:2 to 2:1.

In one or more of the embodiments detailed herein, a weight of the cocoa butter is 0.01 weight percent to 20 weight percent of the product, based on a total weight of the product.

In one or more of the embodiments detailed herein, the total weight of the carbohydrate and the vegetable oil is at least 2 weight percent of the product, based on the total weight of the product.

In one or more of the embodiments detailed herein, the product includes 0.01 to 25 weight percent of saturated fat.

In one or more of the embodiments detailed herein, the product is free of emulisifiers.

In an embodiment, the present invention is a method comprising obtaining at least one of chocolate liquor, sugar, powder whey or milk powder; obtaining cocoa butter; obtaining a carbohydrate comprising at least one of starch, dextrin, or maltodextrin; wherein the carbohydrate has a bulk density of has a bulk density of 0.01 gram/cubic centimeter to 0.4 gram/cubic centimeter; obtaining a vegetable oil; wherein the vegetable oil is an unsaturated fat; mixing the vegetable oil and the carbohydrate to form an oil plated carbohydrate; mixing the at least one of chocolate liquor, sugar, powder whey or milk powder; the cocoa butter, and the oil plated carbohydrate to form a paste; conching the paste; after conching, heating the refined paste; after heating, cooling the heated refined paste to form a chocolate product; wherein the chocolate product comprises 0.01 to 25 weight percent of saturated fat; and wherein a weight percent of the vegetable oil is 30 weight percent to 70 weight percent based on a total weight of the carbohydrate and the vegetable oil.

In one or more of the embodiments detailed herein, the method further comprises refining the paste sufficiently to reduce a particle size of the paste.

In one or more of the embodiments detailed herein, the conching step is conducted for at least 20 hours.

In one or more of the embodiments detailed herein, the heating step comprises exposing the refined paste to a temperature of 40 degrees Celsius to 60 degrees Celsius.

In one or more of the embodiments detailed herein, the cooling step comprises exposing the heated refined paste to a temperature of 5 degrees Celsius to 15 degrees Celsius.

In one or more of the embodiments detailed herein, the carbohydrate in the method is maltodextrin.

In one or more of the embodiments detailed herein, the weight ratio of the carbohydrate to vegetable oil in the method is 1:2 to 2:1.

In one or more of the embodiments detailed herein, the method further comprises packaging the chocolate product to form a packaged chocolate product.

In one or more of the embodiments detailed herein, a weight of the cocoa butter in the method is 0.01 weight percent to 20 weight percent of the product, based on a total weight of the product.

In embodiments, the present invention is a packaged chocolate product comprising a carbohydrate comprising at least one of starch, dextrin, and maltodextrin; wherein the bulk density of the carbohydrate is 0.01 gram/cubic centimeter to 0.4 gram/cubic centimeter. In the embodiments, the chocolate product further includes vegetable oil; wherein the vegetable oil is an unsaturated fat; wherein a weight percent of the vegetable oil is 30 weight percent to 70 weight percent based on the total weight of the carbohydrate and the vegetable oil. In the embodiments, the chocolate product also includes cocoa butter.

In embodiments, the carbohydrate provides structure and ensures that chocolate maintains a solid and set texture. In embodiments, the carbohydrate allows the vegetable oil to be processed along with powdered ingredients used in the chocolate such as sugar. In the embodiments, the carbohydrate may be used to keep the vegetable oil bound during the chocolate processing steps such as conching and tempering and thus, prevent oil separation and/or pooling. In the embodiments, the carbohydrate may also keep the vegetable oil bound when the chocolate is in solid form and thus, prevent the migration or blooming of the vegetable oil.

Also, in embodiments, once the chocolate product is consumed, the carbohydrate may rapidly hydrate and react with amylase in the mouth. The combined effect helps avoid the sensation of powdery coating in the mouth. In embodiments, the plated vegetable oil can help in eliminating the sensation of powderiness. Thus, in embodiments, the carbohydrate and vegetable oil work synergistically to mimic the texture of cocoa butter without the undesirable side-effects of other cocoa butter alternatives such as the sensation of powderiness.

In an embodiment, the present invention is a chocolate product comprising a carbohydrate comprising at least one of starch, dextrin, or maltodextrin; wherein the carbohydrate has a bulk density of i) 0.01 gram/cubic centimeter to 0.6 gram/cubic centimeter, ii) 0.01 gram/cubic centimeter to 0.4 gram/cubic centimeter, or iii) 0.01 gram/cubic centimeter to 0.3 gram/cubic centimeter; vegetable oil; wherein the vegetable oil is an unsaturated fat; cocoa butter; wherein a weight percent of the vegetable oil is 30 weight percent to 70 weight percent based on the total weight of the carbohydrate and the vegetable oil; and wherein the product is a packaged chocolate product.

In embodiments, the present invention is a chocolate product comprising a carbohydrate comprising at least one of starch, dextrin, or maltodextrin, wherein the carbohydrate has a bulk density of i) 0.01 gram/cubic centimeter to 0.6 gram/cubic centimeter, ii) 0.01 gram/cubic centimeter to 0.4 gram/cubic centimeter, or iii) 0.01 gram/cubic centimeter to 0.3 gram/cubic centimeter.

In some embodiments, the present invention may include fat-based fillings use, in chocolate and related products. In embodiments, the creamy fillings include chocolate or alternative flavors, nougat-type fillings, caramel type fillings or other fillings that are used in chocolate and related products.

In one or more embodiments detailed herein, the starch is in the form of a starch granule. Starch granules are present in most plant cells and consist of highly ordered crystalline regions and less organized amorphous regions. When present in this granular state, the starch is referred to as ‘native starch’. In another embodiment, the starch is gelatinized and/or cooked.

Non-limiting examples of starches for use in the present invention are corn, pea, potato, sweet potato, sorghum, banana, barley, wheat, rice, sago, amaranth, tapioca, arrowroot, canna, and low amylose (containing no more than about 10 percent by weight amylose) or high amylose (containing at least about 40 percent by weight amylose) varieties thereof. Genetically modified varieties of these starches may also be suitable starches.

The starch may be chemically modified, enzymatically modified, modified by heat treatment or by physical treatment. The term “chemically modified” or “chemical modification” includes, but is not limited to crosslinking, modification with blocking groups to inhibit retrogradation, modification by the addition of lipophilic groups, acetylated starches, hydroxyethylated and hydroxypropylated starches, inorganically esterified starches, cationic, anionic and oxidized starches, zwitterionic starches, starches modified by enzymes and combinations thereof.

In embodiments, the starches may be prepared using techniques known the art for preparing starches having the appropriate surface area. Non-limiting methods of preparing starches are included in Starch Chemistry and Technology, Whistler, Roy L., 2nd Edition (1984), Academic Press, Inc. New York, N.Y.

In embodiments, the dextrins and maltodextrins suitable for the present invention may be produced by the hydrolysis of one or more of the starches detailed herein. A non-limiting example of a suitable maltodextrin is maltodextrin derived from tapioca and sold by Ingredion under the trademark N-Zorbit® M.

A non-limiting method of making a carbohydrate comprising at least one of starch, dextrin, or maltodextrin having a bulk density within the ranges detailed herein includes using a suitable agent to hollow out granules or particles of the carbohydrate. Another non-limiting method of making the carbohydrate comprising at least one of starch, dextrin, or maltodextrin having a bulk density within the ranges detailed herein includes dissolving the carbohydrate in a suitable solvent and then rapidly drying the carbohydrate using the solvent as an expansion aid to decrease the bulk density during the drying process. In yet another non-limiting method, the carbohydrate may be pregelatizined to aid dissolution in the solvent. Another non-limiting method includes sufficiently agglomerating the carbohydrate particles to reduce the bulk density of the agglomerated carbohydrate to ranges detailed herein. The agglomeration may be conducted by first assembling the carbohydrate particles in emulsion or suspension droplets. Next, the particles in the emulsion or suspension droplets may be coupled by any suitable physical or chemical mechanism such as, but not limited to, chemical modification, the use of radiation to join molecules or other known physical or chemical modification approach known in the art. Finally, the liquid medium is removed to form agglomerated carbohydrate particles having a bulk density in the ranges detailed herein.

In embodiments, the carbohydrate has a bulk density of 0.01 gram/cubic centimeter to 0.6 gram/cubic centimeter. In embodiments, the carbohydrate has a bulk density of 0.1 gram/cubic centimeter to 0.6 gram/cubic centimeter. In embodiments, the carbohydrate has a bulk density of 0.2 gram/cubic centimeter to 0.6 gram/cubic centimeter. In embodiments, the carbohydrate has a bulk density of 0.3 gram/cubic centimeter to 0.6 gram/cubic centimeter. In embodiments, the carbohydrate has a bulk density of 0.4 gram/cubic centimeter to 0.6 gram/cubic centimeter. In embodiments, the carbohydrate has a bulk density of 0.5 gram/cubic centimeter to 0.6 gram/cubic centimeter.

In embodiments, the carbohydrate has a bulk density of 0.01 gram/cubic centimeter to 0.5 gram/cubic centimeter. In embodiments, the carbohydrate has a bulk density of 0.01 gram/cubic centimeter to 0.4 gram/cubic centimeter. In embodiments, the carbohydrate has a bulk density of 0.01 gram/cubic centimeter to 0.45 gram/cubic centimeter. In embodiments, the carbohydrate has a bulk density of 0.01 gram/cubic centimeter to 0.3 gram/cubic centimeter. In embodiments, the carbohydrate has a bulk density of 0.01 gram/cubic centimeter to 0.2 gram/cubic centimeter. In embodiments, the carbohydrate has a bulk density of 0.01 gram/cubic centimeter to 0.1 gram/cubic centimeter.

In embodiments, the carbohydrate has a bulk density of 0.1 gram/cubic centimeter to 0.5 gram/cubic centimeter. In embodiments, the carbohydrate has a bulk density of 0.2 gram/cubic centimeter to 0.4 gram/cubic centimeter.

In embodiments, the carbohydrate has a bulk density of 0.1 gram/cubic centimeter. In embodiments, the carbohydrate has a bulk density of 0.2 gram/cubic centim eter. In embodiments, the carbohydrate has a bulk density of 0.3 gram/cubic centimeter. In embodiments, the carbohydrate has a bulk density of 0.4 gram/cubic centimeter. In embodiments, the carbohydrate has a bulk density of 0.45 gram/cubic centimeter.

In one or more embodiments detailed herein, the vegetable oil is an unsaturated fat. In some embodiments, the vegetable oil comprises at least one of corn oil, soy oil, canola oil, sunflower oil, safflower oil, rapeseed oil, olive oil, cotton oil, and the like. In one or more embodiments detailed herein, the vegetable oil is at least one of corn oil, soy oil, canola oil, sunflower oil, or a combination thereof.

In one or more embodiments detailed herein, a weight percent of the vegetable oil is 30 weight percent to 70 weight percent based on a total weight of the carbohydrate and the vegetable oil. In one or more embodiments detailed herein, a weight percent of the vegetable oil is 35 weight percent to 70 weight percent based on a total weight of the carbohydrate and the vegetable oil. In one or more embodiments detailed herein, a weight percent of the vegetable oil is 40 weight percent to 70 weight percent based on a total weight of the carbohydrate and the vegetable oil. In one or more embodiments detailed herein, a weight percent of the vegetable oil is 45 weight percent to 70 weight percent based on a total weight of the carbohydrate and the vegetable oil. In one or more embodiments detailed herein, a weight percent of the vegetable oil is 50 weight percent to 70 weight percent based on a total weight of the carbohydrate and the vegetable oil. In one or more embodiments detailed herein, a weight percent of the vegetable oil is 60 weight percent to 70 weight percent based on a total weight of the carbohydrate and the vegetable oil.

In one or more embodiments detailed herein, a weight percent of the vegetable oil is 30 weight percent to 65 weight percent based on a total weight of the carbohydrate and the vegetable oil. In one or more embodiments detailed herein, a weight percent of the vegetable oil is 30 weight percent to 60 weight percent based on a total weight of the carbohydrate and the vegetable oil. In one or more embodiments detailed herein, a weight percent of the vegetable oil is 30 weight percent to 55 weight percent based on a total weight of the carbohydrate and the vegetable oil. In one or more embodiments detailed herein, a weight percent of the vegetable oil is 30 weight percent to 50 weight percent based on a total weight of the carbohydrate and the vegetable oil. In one or more embodiments detailed herein, a weight percent of the vegetable oil is 30 weight percent to 45 weight percent based on a total weight of the carbohydrate and the vegetable oil. In one or more embodiments detailed herein, a weight percent of the vegetable oil is 30 weight percent to 40 weight percent based on a total weight of the carbohydrate and the vegetable oil.

In one or more embodiments detailed herein, a weight percent of the vegetable oil is 35 weight percent to 55 weight percent based on a total weight of the carbohydrate and the vegetable oil. In one or more embodiments detailed herein, a weight percent of the vegetable oil is 40 weight percent to 50 weight percent based on a total weight of the carbohydrate and the vegetable oil.

In one or more embodiments detailed herein, a weight ratio of the carbohydrate to vegetable oil is 1:2 to 2:1. In one or more embodiments detailed herein, a weight ratio of the carbohydrate to vegetable oil is 1:1 to 2:1. In one or more embodiments detailed herein, a weight ratio of the carbohydrate to vegetable oil is 1:2 to 1:1. In one or more embodiments detailed herein, a weight ratio of the carbohydrate to vegetable oil is 1:2 to 2:1.

In one or more embodiments detailed herein, the total weight of the carbohydrate and the vegetable oil is at least 2 weight percent of the product, based on a total weight of the product. In one or more embodiments detailed herein, the total weight of the carbohydrate and the vegetable oil is at least 4 weight percent of the product, based on a total weight of the product. In one or more embodiments detailed herein, the total weight of the carbohydrate and the vegetable oil is at least 5 weight percent of the product, based on a total weight of the product.

In one or more embodiments detailed herein, the total weight of the carbohydrate and the vegetable oil is 2 to 40 weight percent of the product, based on a total weight of the product. In one or more embodiments detailed herein, the total weight of the carbohydrate and the vegetable oil is 2 to 35 weight percent of the product, based on a total weight of the product. In one or more embodiments detailed herein, the total weight of the carbohydrate and the vegetable oil is 2 to 30 weight percent of the product, based on a total weight of the product. In one or more embodiments detailed herein, the total weight of the carbohydrate and the vegetable oil is 2 to 25 weight percent of the product, based on a total weight of the product. In one or more embodiments detailed herein, the total weight of the carbohydrate and the vegetable oil is 2 to 20 weight percent of the product, based on a total weight of the product. In one or more embodiments detailed herein, the total weight of the carbohydrate and the vegetable oil is 2 to 15 weight percent of the product, based on a total weight of the product. In one or more embodiments detailed herein, the total weight of the carbohydrate and the vegetable oil is 2 to 10 weight percent of the product, based on a total weight of the product.

In one or more embodiments detailed herein, the total weight of the carbohydrate and the vegetable oil is 4 to 40 weight percent of the product, based on a total weight of the product. In one or more embodiments detailed herein, the total weight of the carbohydrate and the vegetable oil is 5 to 40 weight percent of the product, based on a total weight of the product. In one or more embodiments detailed herein, the total weight of the carbohydrate and the vegetable oil is 7 to 40 weight percent of the product, based on a total weight of the product. In one or more embodiments detailed herein, the total weight of the carbohydrate and the vegetable oil is 10 to 40 weight percent of the product, based on a total weight of the product. In one or more embodiments detailed herein, the total weight of the carbohydrate and the vegetable oil is 15 to 40 weight percent of the product, based on a total weight of the product. In one or more embodiments detailed herein, the total weight of the carbohydrate and the vegetable oil is 20 to 40 weight percent of the product, based on a total weight of the product. In one or more embodiments detailed herein, the total weight of the carbohydrate and the vegetable oil is 30 to 40 weight percent of the product, based on a total weight of the product.

In one or more embodiments detailed herein, the vegetable oil plates the carbohydrate. In one or more embodiments detailed herein, the vegetable oil plates the carbohydrate using a manual mixing process known in the art. In one or more embodiments, the vegetable oil plates the carbohydrate using a spray drying process known in the art.

In one or more embodiments detailed herein, the product comprises 0.01 to 25 weight percent of saturated fat. In one or more embodiments detailed herein, the product comprises 0.01 to 20 weight percent of saturated fat. In one or more embodiments detailed herein, the product comprises 0.01 to 15 weight percent of saturated fat. In one or more embodiments detailed herein, the product comprises 0.01 to 10 weight percent of saturated fat. In one or more embodiments detailed herein, the product comprises 0.01 to 5 weight percent of saturated fat. In one or more embodiments detailed herein, the product comprises 0.01 to 2 weight percent of saturated fat. In one or more embodiments detailed herein, the product comprises 2 to 25 weight percent of saturated fat. In one or more embodiments detailed herein, the product comprises 5 to 25 weight percent of saturated fat. In one or more embodiments detailed herein, the product comprises 10 to 25 weight percent of saturated fat.

In one or more embodiments detailed herein, a weight percent of the cocoa butter is 0.01 weight percent to 25 weight percent the product, based on a total weight of the product. In one or more embodiments detailed herein, a weight percent of the cocoa butter is 0.01 weight percent to 22 weight percent of the product, based on a total weight of the product. In one or more embodiments detailed herein, a weight percent of the cocoa butter is 0.01 weight percent to 20 weight percent of the product, based on a total weight of the product. In one or more embodiments detailed herein, a weight percent of the cocoa butter is 0.01 weight percent to 18 weight percent of the product, based on a total weight of the product. In one or more embodiments detailed herein, a weight percent of the cocoa butter is 0.01 weight percent to 15 weight percent of the product, based on a total weight of the product. In one or more embodiments detailed herein, a weight percent of the cocoa butter is 0.01 weight percent to 13 weight percent of the product, based on a total weight of the product. In one or more embodiments detailed herein, a weight percent of the cocoa butter is 0.01 weight percent to 11 weight percent of the product, based on a total weight of the product. In one or more embodiments detailed herein, a weight percent of the cocoa butter is 0.01 weight percent to 10 weight percent of the product, based on a total weight of the product. In one or more embodiments detailed herein, a weight percent of the cocoa butter is 0.01 weight percent to 8 weight percent of the product, based on a total weight of the product. In one or more embodiments detailed herein, a weight percent of the cocoa butter is 0.01 weight percent to 5 weight percent of the product, based on a total weight of the product.

In one or more embodiments detailed herein, the chocolate product may further comprise one or more ingredients known for use in chocolate such as sugar, powder whey, milk powder, cocoa liquor, vanillin, and/or lecithin.

In embodiments, the product is free of emulsifiers such as polyglycerol polyricinoleate, ammonium phosphatide and citric acid esters. In yet other embodiments, the product includes 0.1 weight percent to 5 weight percent of emulsifiers. In embodiments, the product includes 0.1 weight percent to 4 weight percent of emulsifiers. In yet other embodiments, the product includes 0.1 weight percent to 3 weight percent of emulsifiers. In other embodiments, the product includes 0.1 weight percent to 2 weight percent of emulsifiers. In embodiments, the product includes 0.1 weight percent to 1 weight percent of emulsifiers. In some embodiments, the product includes 0.1 weight percent to 0.5 weight percent of emulsifiers.

In embodiments, the present invention is a method comprises obtaining at least one of chocolate liquor, sugar, powder whey, milk powder, vanillin, or lecithin. In the embodiments, the method further comprises obtaining cocoa butter and a carbohydrate comprising at least one of starch, dextrin, or maltodextrin; wherein the carbohydrate has a bulk density of i) 0.01 gram/cubic centimeter to 0.6 gram/cubic centimeter, ii) 0.01 gram/cubic centimeter to 0.4 gram/cubic centimeter, or iii) 0.01 gram/cubic centimeter to 0.3 gram/cubic centimeter. In the embodiments, the method further comprises obtaining a vegetable oil; wherein the vegetable oil is an unsaturated fat.

In embodiments, the method comprises mixing the vegetable oil and the carbohydrate to form an oil plated carbohydrate. In embodiments, the vegetable oil and the carbohydrate are mixed sufficiently for the vegetable oil to be plated by the carbohydrate. In embodiments, any mixing process known in the art can be used to form the vegetable oil plated carbohydrate. In one or more embodiments detailed herein, the mixing process is a manual mixing process. In one or more embodiments detailed herein, the mixing process used to form the vegetable oil plated carbohydrate is a spray drying process known in the art.

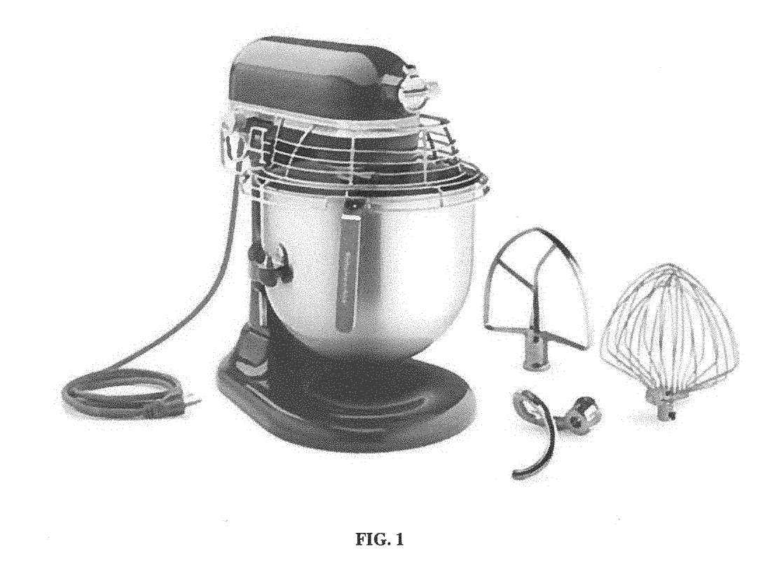

In one or more embodiments detailed herein, the method further comprises mixing the at least one of chocolate liquor, sugar, powder whey or milk powder; the cocoa butter, and the oil plated carbohydrate sufficiently to form a paste. In embodiments, any mixing process known in the art can be used to form the paste. In one or more embodiments detailed herein, the mixing process is a manual mixing process. In one or more embodiments detailed herein, the mixing process is a spray drying process known in the art. A non-limiting example of a mixer that may be used in the method of the present invention is shown in FIG. 1.

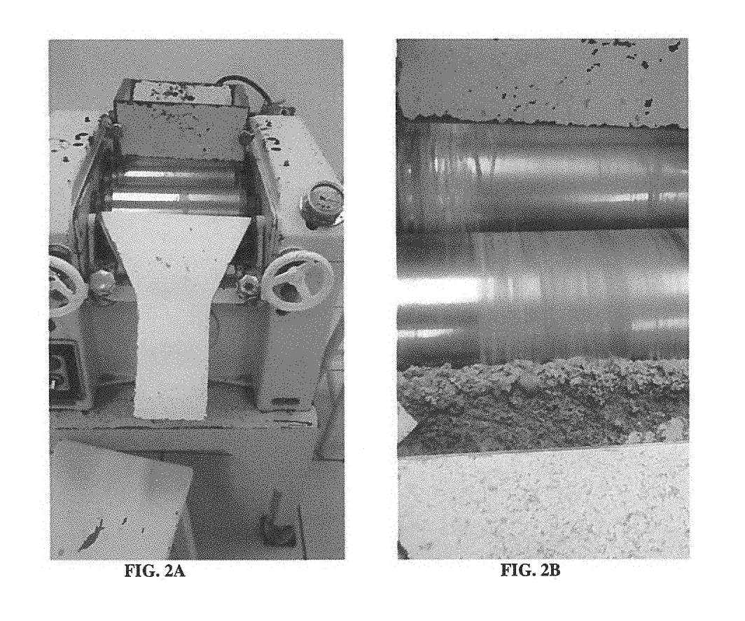

In one or more embodiments detailed herein, the method further comprises refining the paste. In one or more embodiments detailed herein, the refining step comprises reducing the particle size of the paste sufficiently to form flakes. In one or more embodiments detailed herein, the refining step comprises reducing the particle size of the paste by grinding the paste. In the embodiments, the grinding process includes feeding the paste through one or more sets of rollers. In one or more embodiments detailed herein, the refining step comprises reducing the particle size of the paste sufficiently to reduce graininess or sandiness while providing texture. A non-limiting example of a refiner having three rollers that may be used in the method of the present invention is shown in FIGS. 2A and 2B. FIG. 2B shows a close-up view of the refined product coming out of the roller.

In one or more embodiments detailed herein, the refining step comprises reducing the particle size of the paste sufficiently to form flakes having a particle size of 15 to 30 microns. In one or more embodiments detailed herein, the refining step comprises reducing the particle size of the paste sufficiently to form flakes having a particle size of 15 to 25 microns. In one or more embodiments detailed herein, the refining step comprises reducing the particle size of the paste sufficiently to form flakes having a particle size of 15 to 22 microns. In one or more embodiments detailed herein, the refining step comprises reducing the particle size of the paste sufficiently to form flakes having a particle size of 15 to 20 microns. In one or more embodiments detailed herein, the refining step comprises reducing the particle size of the paste sufficiently to form flakes having a particle size of 15 to 18 microns.

In one or more embodiments detailed herein, the refining step comprises reducing the particle size of the paste sufficiently to form flakes having a particle size of 18 to 30 microns. In one or more embodiments detailed herein, the refining step comprises reducing the particle size of the paste sufficiently to form flakes having a particle size of 20 to 30 microns. In one or more embodiments detailed herein, the refining step comprises reducing the particle size of the paste sufficiently to form flakes having a particle size of 22 to 30 microns. In one or more embodiments detailed herein, the refining step comprises reducing the particle size of the paste sufficiently to form flakes having a particle size of 25 to 30 microns.

In one or more embodiments detailed herein, the refining step comprises reducing the particle size of the paste sufficiently to form flakes having a particle size of 18 to 27 microns. In one or more embodiments detailed herein, the refining step comprises reducing the particle size of the paste sufficiently to form flakes having a particle size of 18 to 22 microns.

In one or more embodiments detailed herein, the method further comprises conching the paste. In one or more embodiments detailed herein, the conching step includes constant agitation. In embodiments, the conching step includes processing the refined paste in a machine having one or more large paddles or rollers configured to knead, agitate and/or aerate the refined paste.

In one or more embodiments detailed herein, the conching step is conducted for 2 hours to 72 hours. In one or more embodiments detailed herein, the conching step is conducted for 2 hours to 60 hours. In one or more embodiments detailed herein, the conching step is conducted for 2 hours to 50 hours. In one or more embodiments detailed herein, the conching step is conducted for 2 hours to 40 hours. In one or more embodiments detailed herein, the conching step is conducted for 2 hours to 30 hours. In one or more embodiments detailed herein, the conching step is conducted for 2 hours to 20 hours. In one or more embodiments detailed herein, the conching step is conducted for 2 hours to 10 hours.

In one or more embodiments detailed herein, the conching step is conducted for 5 hours to 72 hours. In one or more embodiments detailed herein, the conching step is conducted for 10 hours to 72 hours. In one or more embodiments detailed herein, the conching step is conducted for 20 hours to 72 hours. In one or more embodiments detailed herein, the conching step is conducted for 30 hours to 72 hours. In one or more embodiments detailed herein, the conching step is conducted for 40 hours to 72 hours. In one or more embodiments detailed herein, the conching step is conducted for 50 hours to 72 hours. In one or more embodiments detailed herein, the conching step is conducted for 60 hours to 72 hours.

In one or more embodiments detailed herein, the conching step is conducted for about 20 hours.

In yet another embodiment, the conching step is replaced by an alternative mixin step suitable for the type of chocolate-based product being manufactured.

In embodiments, after conching, the method includes heating the refined paste. In one or more embodiments detailed herein, the refined paste is heated sufficiently to melt Alpha and Beta prime form crystals in the refined paste. In one or more embodiments detailed herein, the refined paste is heated sufficiently to promote nucleation/crystal growth in the refined paste. In embodiments, the refined paste is monitored using a temper meter during the heating process. In the embodiments, the temper meter is used to detect the presence of various crystals such as Alpha and Beta prime form crystals. A non-limiting example of a temper meter is a Tempermeter E4 manufactured by Sollich® of Germany.

In one or more embodiments detailed herein, the heating step comprises exposing the refined paste to a temperature of 40 degrees Celsius to 80 degrees Celsius. In one or more embodiments detailed herein, the heating step comprises exposing the refined paste to a temperature of 40 degrees Celsius to 70 degrees Celsius. In one or more embodiments detailed herein, the heating step comprises exposing the refined paste to a temperature of 40 degrees Celsius to 60 degrees Celsius. In one or more embodiments detailed herein, the heating step comprises exposing the refined paste to a temperature of 40 degrees Celsius to 55 degrees Celsius. In one or more embodiments detailed herein, the heating step comprises exposing the refined paste to a temperature of 40 degrees Celsius to 50 degrees Celsius. In one or more embodiments detailed herein, the heating step comprises exposing the refined paste to a temperature of 40 degrees Celsius to 45 degrees Celsius.

In one or more embodiments detailed herein, the heating step comprises exposing the refined paste to a temperature of 45 degrees Celsius to 80 degrees Celsius. In one or more embodiments detailed herein, the heating step comprises exposing the refined paste to a temperature of 50 degrees Celsius to 80 degrees Celsius. In one or more embodiments detailed herein, the heating step comprises exposing the refined paste to a temperature of 55 degrees Celsius to 80 degrees Celsius. In one or more embodiments detailed herein, the heating step comprises exposing the refined paste to a temperature of 60 degrees Celsius to 80 degrees Celsius. In one or more embodiments detailed herein, the heating step comprises exposing the refined paste to a temperature of 65 degrees Celsius to 80 degrees Celsius. In one or more embodiments detailed herein, the heating step comprises exposing the refined paste to a temperature of 70 degrees Celsius to 80 degrees Celsius.

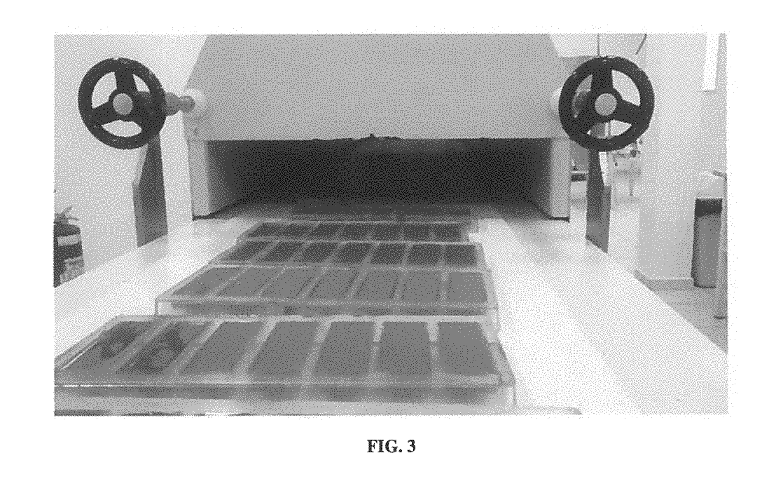

In embodiments, after heating, the method includes cooling the heated refined paste. In one or more embodiments detailed herein, the cooling step is conducted at a sufficient time and sufficient temperature to solidify the heated refined paste. A non-limiting example of an air cooling tunnel that may be used for the cooling step of the method of the present invention is illustrated in FIG. 3.

In one or more embodiments detailed herein, the cooling step comprises exposing the heated refined paste to a temperature of 2 degrees Celsius to 20 degrees Celsius. In one or more embodiments detailed herein, the cooling step comprises exposing the heated refined paste to a temperature of 5 degrees Celsius to 20 degrees Celsius. In one or more embodiments detailed herein, the cooling step comprises exposing the heated refined paste to a temperature of 8 degrees Celsius to 20 degrees Celsius. In one or more embodiments detailed herein, the cooling step comprises exposing the heated refined paste to a temperature of 12 degrees Celsius to 20 degrees Celsius. In one or more embodiments detailed herein, the cooling step comprises exposing the heated refined paste to a temperature of 15 degrees Celsius to 20 degrees Celsius. In one or more embodiments detailed herein, the cooling step comprises exposing the heated refined paste to a temperature of 2 degrees Celsius to 15 degrees Celsius. In one or more embodiments detailed herein, the cooling step comprises exposing the heated refined paste to a temperature of 2 degrees Celsius to 12 degrees Celsius. In one or more embodiments detailed herein, the cooling step comprises exposing the heated refined paste to a temperature of 2 degrees Celsius to 8 degrees Celsius. In one or more embodiments detailed herein, the cooling step comprises exposing the heated refined paste to a temperature of 2 degrees Celsius to 5 degrees Celsius.

In one or more embodiments detailed herein, the cooling step comprises exposing the heated refined paste to a temperature of 5 degrees Celsius to 15 degrees Celsius. In one or more embodiments detailed herein, the cooling step comprises exposing the heated refined paste to a temperature of 7 degrees Celsius to 10 degrees Celsius.

In one or more embodiments detailed herein, the cooling step is conducted for 5 minutes to 60 minutes. In one or more embodiments detailed herein, the cooling step is conducted for 5 minutes to 50 minutes. In one or more embodiments detailed herein, the cooling step is conducted for 5 minutes to 40 minutes. In one or more embodiments detailed herein, the cooling step is conducted for 5 minutes to 30 minutes. In one or more embodiments detailed herein, the cooling step is conducted for 5 minutes to 20 minutes. In one or more embodiments detailed herein, the cooling step is conducted for 5 minutes to 10 minutes.

In one or more embodiments detailed herein, the cooling step is conducted for 10 minutes to 60 minutes. In one or more embodiments detailed herein, the cooling step is conducted for 20 minutes to 60 minutes. In one or more embodiments detailed herein, the cooling step is conducted for 30 minutes to 60 minutes. In one or more embodiments detailed herein, the cooling step is conducted for 40 minutes to 60 minutes. In one or more embodiments detailed herein, the cooling step is conducted for 50 minutes to 60 minutes.

In one or more embodiments detailed herein, the cooling step is conducted for 20 minutes to 50 minutes. In one or more embodiments detailed herein, the cooling step is conducted for 30 minutes to 40 minutes. In one or more embodiments detailed herein, the cooling step is conducted for 20 minutes.

In embodiments, after cooling, the method further includes packaging the chocolate product. In one or more embodiments detailed herein, the method includes forming a packaged product having one or more chocolate products therein. In one or more embodiments detailed herein, the method includes forming a packaged product having 2 to 20 chocolate products therein. In one or more embodiments detailed herein, the method includes forming a packaged product having 4 to 15 chocolate products therein. In one or more embodiments detailed herein, the method includes forming a packaged product having 6 to 12 chocolate products therein.

### NON-LIMITING EXAMPLES

Seven batches of milk chocolate having the formulations detailed in Tables 1 and 2 were made according to the procedure detailed below.

TABLE 1

| FORMULATION | Batch 1 | Batch 2 | Batch 3 | Batch 4 |
|---|---|---|---|---|
| MILK CHOCOLATE | (wt. %) | (wt. %) | (wt. %) | (wt. %) |
| Ground sucrose | 45.47 | 46.47 | 45.47 | 45.47 |
| Ionex powder whey 40% | 5.03 | 6.03 | 5.03 | 5.03 |
| Cocoa butter replacer | — | — | 5 | 5 |
| Whole powder milk | 17.4 | 18.4 | 17.4 | 17.4 |
| Cocoa liquor | 11.1 | 12.1 | 11.1 | 11.1 |
| Cocoa butter | 20.2 | 15.2 | 15.2 | 15.2 |
| (deodorized) | | | | |
| Vanillin | 0.1 | 0.1 | 0.1 | 0.1 |
| Lecithin | 0.4 | 0.4 | 0.4 | 0.4 |
| Polyglycerol | 0.3 | 0.3 | 0.3 | 0.3 |
| polyricinoleate | | | | |

TABLE 2

| FORMULATION | Batch 5 | | |
|---|---|---|---|
| MILK CHOCOLATE | (wt. %) | Batch 6 (wt. %) | Batch 7 (wt. %) |
| Ground sucrose | 46.47 | 45.47 | 45.47 |
| Ionex powder whey | 6.03 | 5.03 | 5.03 |
| 40% | | | |
| Cocoa butter replacer | — | 5 | 5 |
| Whole powder milk | 18.4 | 17.4 | 17.4 |
| Cocoa liquor | 12.1 | 11.1 | 11.1 |
| Cocoa butter | 15.2 | 15.2 | 15.2 |
| (deodorized) | | | |
| Vanillin | 0.1 | 0.1 | 0.1 |
| Lecithin | 0.4 | 0.4 | 0.4 |
| Polyglycerol | 0.3 | 0.3 | 0.3 |
| polyricinoleate | | | |

Batch 1: Standard (market base) with 20% cocoa butter.

Batch 2: Negative standard (reduce cocoa butter by 5%) without any replacer and increasing proportionally other ingredients.

Batch 3: Cocoa butter replacer: 5% replacement by cocoa butter equivalent (CBE)—commercial alternative based on hydrogenated oil from Loders Croklaan.

Batch 4: Cocoa butter replacer: 5% replacement by 60% N Zorbit® M (tapioca maltodextrin) plating 40% soy oil consistent with embodiments of the present invention.

Batch 5: Negative control: cocoa butter removed and all other ingredients increased proportionally.

Batch 6: Cocoa butter replacer: 10 DE maltodextrin with low (bulk density of about 1 gram/cubic centimeter).

Batch 7: Cocoa butter replacer: dextrin.

Procedure for producing Batches 1 to 7

The ingredients in each batch of Tables 1 and 2 were first mixed to obtain a paste having the consistency of dough. For Batch 4, the N Zorbit® M and soy oil were first mixed to plate the oil and then added to the other ingredients.

The pastes were then refined using a set of rollers to crush the paste into flakes having a particle size of 18 to 22 microns. Particle size was analyzed using a micrometer at the initial, middle and end of the refining process.

The refined paste was then subjected to conching under agitation using a conching machine Model INCO PPA 20 having multiple paddles for about 20 hours.

The conched chocolate was then heated to 48 degrees Celsius to melt the alpha and beta prime form crystals and promote nucleation and crystal growth in the fluid chocolate mass. During the heating step, a temper meter was used to measure the presence of various types of the crystal forms IV (beta prime 1) and V (beta 2).

The heated chocolate was then cooled by conveying through controlled cooling tunnels at a temperature of 8 degrees Celsius to 10 degrees Celsius for about 20 minutes to form the solidified chocolate product.

The batches were subjected to various tests to determine characteristics of the chocolate products. The results of the testing are shown in Table 3:

TABLE 3

| FORMULATION | | | | | |
|---|---|---|---|---|---|
| MILK | | | | | |
| CHOCOLATE | Batch 1 | Batch 2 | Batch 3 | Batch 4 | Batch 5 |
| Particle Size (μ) | 19 | 19 | 19 | 19 | 19 |
| Temper | 27.5 | 26.8 | 26.7 | 27.6 | 26.8 |
| temperature ° C. | | | | | |
| Temper index | 4.6 | 5.7 | 4.6 | 4.4 | 5.7 |
| Mass viscosity at | Viscosity | More | Less viscous | Same as standard | More viscous |
| tempering | typical | viscous than | than standard | | than standard |
| | | standard | | | |
| Bright | Standard | Same as | Same as | Same as standard | Same as standard |
| | | standard | standard | | |
| Particles | No | Particulate | No | Small particles | Particulate |
| perception | | sensation in | | during conching/ | sensation in the |
| | | the mouth | | tempering | mouth during |
| | | during | | | tasting |
| | | tasting | | | |
| Molding | ok | ok | ok | ok | ok |

Preparation: Batches 1-5 were readily prepared. Preparation of batch 4 resulted in no separation of vegetable oil during the conching step.

For batches 6 and 7 that include a typical (low surface area/high bulk density) maltodextrin and dextrin, the premix of oil and carbohydrate did not result in a uniform mixture. In batches 6 and 7, the oil was unstructured due to lack of available surface area and clear separation was visible in the mix. The production of chocolate was initiated using both mixes but the batches were abandoned after the conching step as there was clear separation of oil observed in the mixer. There was also the appearance of agglomerated particles observed on the surface of the mix. Thus, batches 6 and 7 that include the typical (low surface area/high bulk density) maltodextrin and dextrin did not provide the desired impact on stabilization of the oil.

Sensory Testing: Batches 1-4 were tested for snap, bite, toothpacking and meltaway using standard sensory testing procedures. The batches were compared to each other by the evaluators using a basic comparison test. Batch 4 according to embodiments of the present invention exhibited similar characteristics including chewiness and meltaway to standard chocolate—Batch 1 having 20.2 wt. % cocoa butter—even with a reduction of 5% of cocoa butter in the formulation of Batch 4. Batch 3 that includes the CBE showed similar sensory characteristics as the control. The only batch that used unsaturated fat to replace cocoa butter was Batch 4 having N-Zorbit® M.

Stability testing: Batches 1-4 were held under controlled atmosphere for over six months. The batches were examined for any signs of ageing. Batch 4 having the N-Zorbit® M was also examined for oil separation. No signs of any deterioration or ageing were noted. No oil separation or softening of Batch 4 with the N-Zorbit® M and vegetable oil according to embodiments of the present invention was detected.

Impact of oil content: The amount of oil relative to the amount of maltodextrin in the oil plated carbohydrate affects sensory performance. Multiple chocolate batches having oil plated carbohydrates with varying amounts of oil and maltodextrin were tested. Batches having oil plated carbohydrates with less than 30 wt % oil (greater than 70 wt % maltodextrin) exhibited significant sensory issues such as clumps of dehydrated maltodextrin that were perceived in the chocolate as sandiness/graininess and thus, detracted from the sensory indulgence of the chocolate. Batches having oil plated carbohydrates with more than 60 wt % oil (less than 40 wt % maltodextrin) exhibited oil separation during the preparation of the chocolate and in the final product. Moreover, the final product was softer than a control and the sensory qualities were less than desired and resulted in a significantly rapid meltaway. Batches having oil plated carbohydrates with 30 wt % to 60 wt % oil (70 wt % to 40 wt % maltodextrin) showed improved sensory performance compared to the batches having oil plated carbohydrates with less than 30 wt % or greater than 60 wt % oil.

Other maltodextrins: Additional batches having oil plated carbohydrate formed from other types of maltodextrins or dextrins (non-encapsulating) exhibited sandiness or graininess compared with batches having oil plated carbohydrate formed from N-Zorbit® M. The use of carbohydrates by themselves, or as simple mixtures with oil also resulted in sandiness or graininess.

Additional testing was conducted using chocolate batches having carbohydrates with a bulk density of greater than 0.6 grams/cubic centimeter. The resultant chocolate products exhibited sandiness or graininess compared with the chocolate batches having N-Zorbit® M.

While a number of embodiments of the present invention have been described, it is understood that these embodiments are illustrative only, and not restrictive, and that many modifications may become apparent to those of ordinary skill in the art. Further still, the various steps may be carried out in any desired order (and any desired steps may be added and/or any desired steps may be eliminated).

We claim:

1. A product comprising:
a carbohydrate;
wherein the carbohydrate comprises at least one of starch, dextrin, or maltodextrin;
wherein the carbohydrate has a bulk density of 0.01 gram/cubic centimeter to 0.4 gram/cubic centimeter;
vegetable oil;
wherein the vegetable oil is an unsaturated fat;
wherein a weight percent of the vegetable oil is 30 weight percent to 70 weight percent based on a total weight of the carbohydrate and the vegetable oil;
cocoa butter; and
wherein the product is a chocolate product.

2. The product of claim 1, wherein the carbohydrate is selected from the group consisting of starch, dextrin, and maltodextrin.

3. The product of claim 1, wherein the carbohydrate is maltodextrin.

4. The product of claim 3, wherein the maltodextrin is tapioca maltodextrin.

5. The product of claim 1, wherein the vegetable oil comprises at least one of corn oil, soy oil, canola oil, or sunflower oil.

6. The product of claim 1, wherein a weight ratio of the carbohydrate to the vegetable oil is 1:2 to 2:1.

7. The product of claim 1, wherein a weight percent of the cocoa butter is 0.01 weight percent to 20 weight percent of the product, based on the total weight of the product.

8. The product of claim 1, wherein the total weight of the carbohydrate and the vegetable oil is at least 2 weight percent of the product, based on the total weight of the product.

9. The product of claim 1, wherein the product comprises 0.01 to 25 weight percent of saturated fat.

10. The product of claim 1, wherein the product is free of emulisifiers.

11. A method comprising:
obtaining at least one of chocolate liquor, sugar, powder whey or milk powder;
obtaining cocoa butter;
obtaining a carbohydrate;
wherein the carbohydrate comprises at least one of starch, dextrin, or maltodextrin;
wherein the carbohydrate has a bulk density of 0.01 gram/cubic centimeter to 0.4 gram/cubic centimeter;
obtaining a vegetable oil;
wherein the vegetable oil is an unsaturated fat;
mixing the vegetable oil and the carbohydrate to form an oil plated carbohydrate;
mixing the at least one of chocolate liquor, sugar, powder whey or milk powder; the cocoa butter, and the oil plated carbohydrate to form a paste;
conching the paste;
after conching, heating the refined paste;
after heating, cooling the heated refined paste to form a chocolate product;
wherein the chocolate product comprises 0.01 to 25 weight percent of saturated fat; and
wherein a weight percent of the vegetable oil is 30 weight percent to 70 weight percent based on a total weight of the carbohydrate and the vegetable oil.

12. The method of claim 11, further comprising refining the paste sufficiently to reduce a particle size of the paste.

13. The method of claim 11, wherein the conching step is conducted for at least 20 hours.

14. The method of claim 11, wherein the heating step comprises exposing the refined paste to a temperature of 40 degrees Celsius to 60 degrees Celsius.

15. The method of claim 11, wherein the cooling step comprises exposing the heated refined paste to a temperature of 5 degrees Celsius to 15 degrees Celsius.

16. The method of claim 11, wherein the carbohydrate is maltodextrin.

17. The method of claim 11, wherein a weight ratio of the carbohydrate to vegetable oil is 1:2 to 2:1.

18. The method of claim 11, further comprising packaging the chocolate product to form a packaged chocolate product.

19. The method of claim 11, wherein a weight of the cocoa butter is 0.01 weight percent to 20 weight percent of the product, based on a total weight of the product.

20. A product comprising:
a carbohydrate;
wherein the carbohydrate comprises at least one of starch, dextrin, or maltodextrin;
wherein the carbohydrate has a bulk density of 0.01 gram/cubic centimeter to 0.4 gram/cubic centimeter,
vegetable oil;
wherein the vegetable oil is an unsaturated fat;
cocoa butter;
wherein a weight percent of the vegetable oil is 30 weight percent to 70 weight percent based on the total weight of the carbohydrate and the vegetable oil; and
wherein the product is a packaged chocolate product.
